(19) United States
(12) Patent Application Publication
(10) Pub. No.: US 2009/0276859 A1
(43) Pub. Date: Nov. 5, 2009

(54) MEDIA CONTENT TRANSCODING

(75) Inventor: Jukka Ojanen, Vantaa (FI)

Correspondence Address: LADAS & PARRY LLP, 26 WEST 61ST STREET, NEW YORK, NY, 10023, US

(73) Assignee: LINKOTEC OY, Espoo (FI)

(21) Appl. No.: 12/306,062

(22) PCT Filed: Jul. 5, 2007
(86) PCT No.: PCT/FI2007/050415

§ 371 Date: Dec. 22, 2008

Related U.S. Application Data
(60) Provisional application No. 60/830,524, filed on Jul. 13, 2006.

(30) Foreign Application Priority Data
Jul. 7, 2006 (FI) 20065486

(51) Int. Cl. H04L 9/32; G06F 9/46

(52) U.S. Cl. 726/27; 718/102

(57) ABSTRACT

A software product for media content transcoding is a software component configured to be executed under a software application and contains a plurality of internal transcoding subcomponents for transcoding a plurality of audio and/or video formats. It also contains DRM support code for digital rights management [‘DRM’], wherein the DRM has at least an enabled state and wherein the DRM support code contains subcomponents for supporting a plurality of media container formats. At least when the DRM is in the enabled state, the software product is configured to perform the transcoding without intermediate files and by using only the internal transcoding subcomponents for transcoding.

### FIELD OF THE INVENTION

The invention relates to methods and program products for transcoding media content. Transcoding means digital-to-digital conversion from one codec to another, without performing intermediate digital-to-analogue and analogue-to-digital conversions. An illustrative example of media content transcoding is a process of decoding/decompressing incoming data to a raw intermediate format, such as PCM for audio or YUV for video, and then re-encoding the raw intermediate format into a selected target format.

### BACKGROUND OF THE INVENTION

The invention generally relates to a multimedia framework, which means a software structure or architecture for handling media content on a computer platform, usually offering an application programming interface (“API”) and a modular design. The modular design facilitates adding support for new codecs or container formats. The multimedia framework can be used by media players and audio/video editors. Commercial implementation examples include Microsoft® Windows DirectShow/Video for Windows, Real Networks® Helix and Apple® QuickTime. Open software implementation examples include FFMpeg, Gstreamer, Open Mash and Xine.

The invention also relates to Digital Rights Management (DRM). DRM is an umbrella term for any of several technologies used to enforce pre-defined policies for controlling access to hardware and/or digital data, which may contain software, audio still or live images or any combination thereof. In a typical but non-restrictive implementation, a DRM framework handles description, layering, analysis, valuation, trading, monitoring and/or enforcement of usage restrictions that accompany a specific instance of a digital work. In the widest possible sense, the term “DRM” refers to any such management. Commercial implementation examples include Microsoft® Windows Media DRM, Apple® FairPlay DRM (iTunes) and OMA Open Mobile Alliance (OMA) DRM.

FIGS. 1 and 2 illustrate the structure and operation of a prior art multimedia framework. Microsoft® Windows DirectShow will be used as an example. FIG. 1 shows an example of DirectShow framework model. A building block of DirectShow is a software component known as a filter. A filter is a software component that performs some operation on a multimedia stream. A file source filter reads a source file, such as an AVI file (AVI=audio-video interleaved) from the computer's hard disk. An AVI splitter filter parses the file into two streams, namely a compressed video stream and an audio stream. An AVI decompressor filter decodes the video frames. A video renderer filter draws the frames to the display. A default DirectSound device filter plays the audio stream, using DirectSound. As shown in FIG. 1, each filter is connected to one or more other filters. The filters' connection points are called “pins”. Each filter is implemented as separate component which normally means as separate DLL (Dynamic Link Library) file.

The operation of this framework is illustrated in FIG. 2. Initially, the application creates a runtime instance of the Filter Graph Manager. The application then uses the Filter Graph Manager to build a filter graph. The exact set of filters in the graph will depend on the specific application. Next, the application uses the Filter Graph Manager to control the filter graph and to stream data through the filters. The Filter Graph Manager uses a technique called “Intelligent Connect” which covers a set of algorithms that are used to build all or part of a filter graph. Whenever the Filter Graph Manager requires additional filters to complete the graph, it proceeds roughly as follows. If the filter graph contains a filter with at least one unconnected input pin, the Filter Graph Manager tries to use that filter. Otherwise, the Filter Graph Manager looks in the Windows registry for filters that can accept the correct media type for the connection. Each filter has a registry value called “Merit” which roughly indicates how likely the filter is to be useful in completing the graph. The Filter Graph Manager tries the filters in merit-value order. For each stream type (such as audio, video or MIDI), the default renderer has a high merit. Decoders also have a high merit. Special-purpose filters have a low merit.

If the Filter Graph Manager gets stuck and cannot complete the filter graph, it will back out and try a different combination of filters. For the Filter Graph Manager to succeed in building the filter graph, each necessary DLL (filter) must be installed on the computer running the application.

The multimedia frameworks as generally described above exhibit certain problems. For instance, their security against hacking attempts is far from perfect. The vulnerability to hacking stems from the open, modular design of the prior art multimedia frameworks. For instance, it is possible to replace a filter by another one which performs the function(s) of the original filter and copies an unprotected version of the data stream to a file.

For example, US patent application 2005/0132208 by Joshua Hug et al. discloses a technique for auto-negotiation of content output formats using a secure component model. Hug approaches security problems by building a modular design based on dynamic trust-building. An aspect of the invention disclosed by Hug is a method of transcoding a secure content object, comprising: identifying an input format of the secure content object; identifying capabilities of a receiving device to which the secure content object is to be transferred; determining an output format for the secure content object based upon the identified capabilities; dynamically identifying a plurality of trusted processing components to collectively transcode the secure content object from the identified input format to the determined output format; and authenticating each of the trusted processing components prior to the respective processing component operating on the secure content object.

A problem recognized by Hug et al. is that consumers who wish to transfer secure (DRM-protected) content to a playback device, are limited by both the type of device the content can be transferred to, as well as the operations that the playback device is allowed to perform on the content. Hug et al. recognize a desire for a simplified mechanism for transferring secure content to playback devices.

### BRIEF DESCRIPTION OF THE INVENTION

An object of the invention is to develop methods and software products which alleviate one or more of the problems in the prior art multimedia frameworks. The present invention is partly based on the realization that the approach adopted by Hug et al., namely enhanced flexibility and extendibility, may compromise security. For example, Hug's technique involves unencrypted inter-process communication in cases where all involved components are not located in the same process space (see eg FIG. 4, block 410). Such unencrypted inter-process communication may leave processing traces which are open for hackers to study. The object of the invention is achieved by methods and software products which are defined in the attached independent claims. The dependent claims present some specific embodiments of the invention.

A first aspect of the invention is a software product for media content transcoding, wherein the software product:
is a software component configured to be executed under a software application;
contains a plurality of internal transcoding subcomponents for transcoding a plurality of audio and/or video formats;
contains DRM support code for digital rights management [“DRM”], wherein the DRM has at least an enabled state and wherein the DRM support code contains subcomponents for supporting a plurality of media container formats; and
wherein, at least when said DRM is in the enabled state, the software product is configured to perform said transcoding without intermediate files and by using only said internal transcoding subcomponents for transcoding.

In another aspect, the invention is a computer system comprising a software product according to the first aspect. In yet another aspect, the invention is method for transcoding media content, the method comprising transcoding media content by a software product according to the first aspect.

The fact that the invention is implemented as a single monolithic software component, as opposed to a plurality of dynamically linked encoding and decoding components, makes the computer system far less vulnerable to hacking. By virtue of the tight integration, the inventive software component cannot be infiltrated as “Trojans”, ie, malicious software routines masquerading as useful ones. And the implementation as a single monolithic software component causes all communication between transcoding (sub)components to be in-process, instead of inter-process, which helps to solve a hard-to-detect problem in the Hug et al. invention.

The fact that the software component is configured to be executed under a software application brings about the benefit that the software component has no user interface of its own which needs to be changed for different applications; rather each application provides its own user interface. This feature also provides a level of expandability without risking the integrity which is essential for immunity against hacking.

The fact that the software component contains a plurality of internal transcoding subcomponents for transcoding a plurality of audio and/or video formats means that there is little or no need for external transcoding subcomponents; indeed, at least when DRM enforcement is enabled, the use of any external transcoding subcomponents is prohibited. As a further benefit, the integration of the transcoding subcomponents eliminates any need for inter-process calls via the underlying platform's application programming interface (“API”). In addition to a security benefit, this brings about a speed benefit as well.

The fact that the software component according to the invention contains DRM (digital rights management) support code means that the software component can be used for transcoding DRM-protected media files or streams. The DRM has at least an enabled state, which means that the inventive software component at least has an operating mode in which DRM rights are enforced. When DRM enforcement is enabled, the software component performs transcoding without intermediate files. Transcoding without intermediate files can be implemented by performing the transcoding entirely in volatile read-write memory. This feature helps to ensure that potential hackers have no intermediate files at their disposal, which might be useful for regenerating unprotected media files. Also, the transcoding operation of the inventive software component leaves no traces on the underlying platform's memory or hard disk. Such traces might provide clues to the internal operation of the transcoding components.

In some embodiments, the inventive software component may have other operating modes in which DRM enforcement is disabled. In such operating modes, the ban on external transcoding components may be relaxed.

In one embodiment, the software product according to the invention is configured to use a static linking of the internal transcoding subcomponents at least when said DRM is in the enabled state. The static linking helps to eliminate errors and brings about a speed benefit by eliminating the recursive and stepwise build-up of a multimedia framework which was described in connection with FIGS. 1 and 2.

Some benefits of the invention and its embodiments, particularly its speed-related benefits, can be utilized when the inventive software product is executed at a media producer's site. But the benefits of the invention are utilized to the fullest extent if the software product according to the invention is executed in a client computer system. This is because client computer systems are hostile environments as regards vulnerability to hacking and tampering. Particularly in cases wherein the inventive software component configure to be executed in a client computer system, it should be delivered with adequate protection means against hacking, tampering or the like, such that it will be reasonably certain that the functionality of the software component cannot be defeated of circumvented using widely available or specialized software tools. The issue of reasonable certainty is more a legal requirement rather than a technical one, and the required level of protection is defined by media copyright proprietors. One typical implementation comprises protecting the software component with code obfuscation. This means that the object code, when stored in a disk file, is unintelligible to debugging or disassembly software. Only authorized applications are able to open the code obfuscation.

### BRIEF DESCRIPTION OF THE DRAWINGS

In the following the invention will be described in greater detail by means of specific embodiments with reference to the attached drawings, in which:

FIGS. 1 and 2, which have already been described, illustrate the structure and operation of prior art multimedia frameworks;

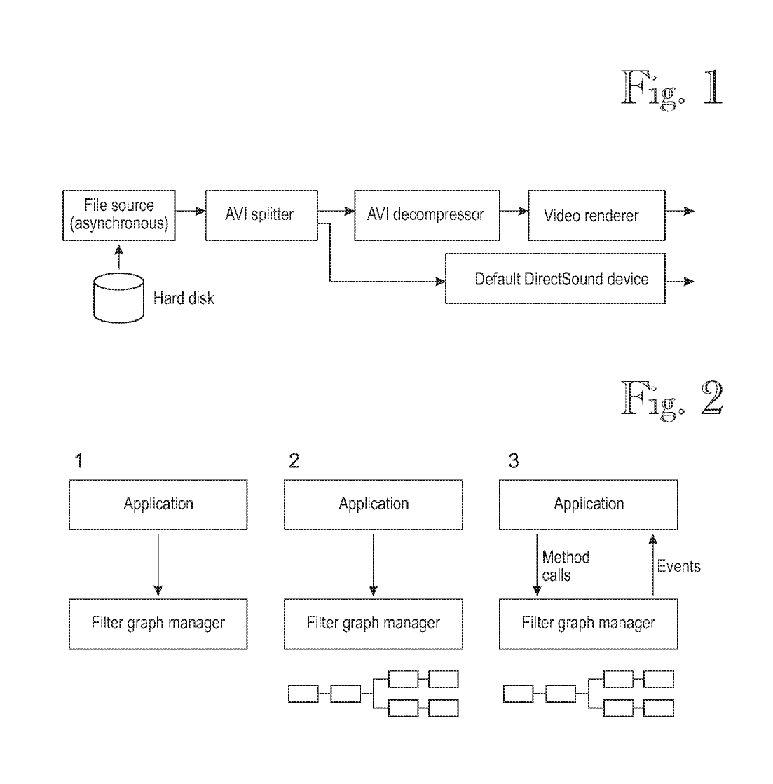

FIG. 3 shows an implementation example of the present invention; and

FIG. 4 shows an exemplary linking of processes for video conversion from an AVI file to an OGM file.

### DETAILED DESCRIPTION OF SPECIFIC EMBODIMENTS

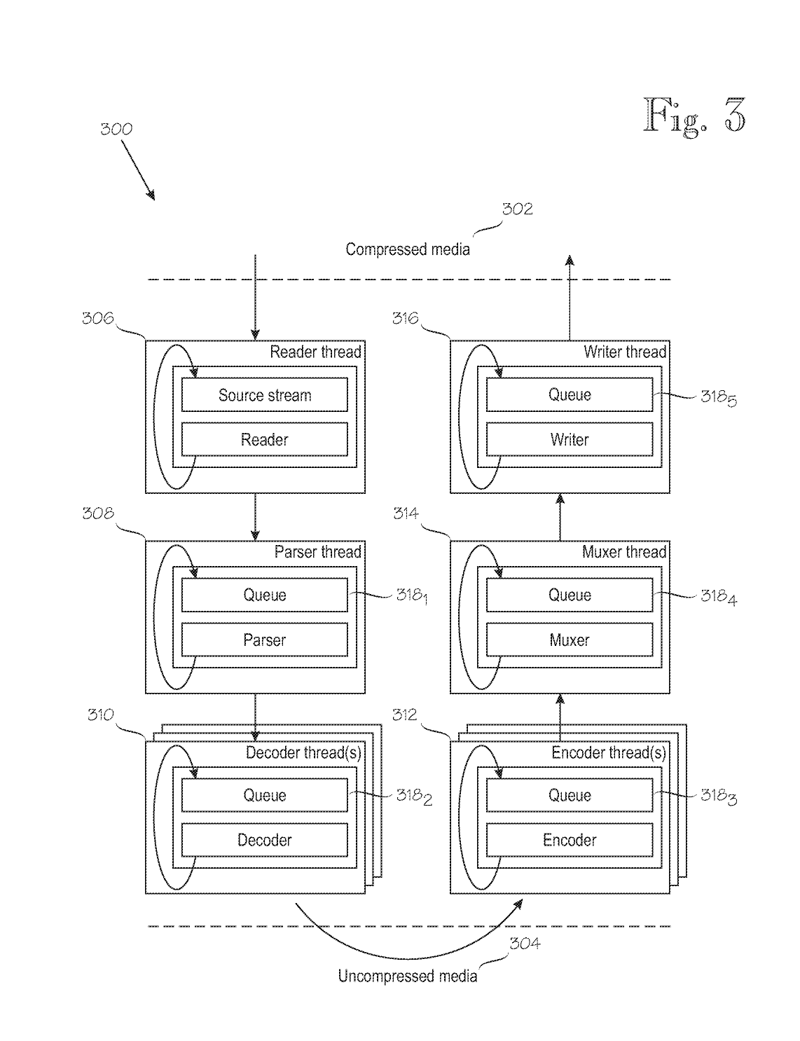

FIG. 3 shows an implementation example of the present invention. A typical embodiment of the present invention implements six processes. The processes include reader, parser, decoder, encoder, multiplexer and writer. They are arranged as pairs of complementary processes as follows: reader-writer, parser-multiplexer and decoder-encoder.

FIG. 3 shows an embodiment in which multithreading is used to distribute the six processes among a plurality of threads. In the embodiment shown in FIG. 3, three threads, namely a reader thread 306, a parser thread 308 and at least one decoder thread 310 convert compressed, and optionally DRM-protected, media 302 to uncompressed media 304. A corresponding set of threads, namely at least one encoder thread 312, a multiplexer (“muxer”) thread 314 and a writer thread 316 carry out the complementary tasks of converting uncompressed media 304 to compressed, and optionally DRM-protected, media 302.

The distribution of processes among a plurality of threads improves system performance. In a further developed embodiment, the communication between the threads takes place asynchronously. A benefit of the asynchronous inter-thread (or inter-process) communication is that a preceding thread does not have to wait until its successor can accept new input. The threads may intercommunicate via queues (buffers) 318₁ through 318₅. Asynchronous operation may be maintained as long as the queue buffers do not overflow. FIG. 3 shows an illustrative example in which there is precisely one buffer between each pair or predecessor-successor thread, but this is not a restrictive example, and the number of buffers may vary.

The task of the reader thread 306 is to obtain input media content 302. The input media content may be obtained from a disk file, a memory area or peripheral device, such as a network stream or USB device. The reader thread is responsible for decrypting DRM-protected content, such as Windows® Media DRM or DVD CSS. The reader thread passes its output to the parser thread 308.

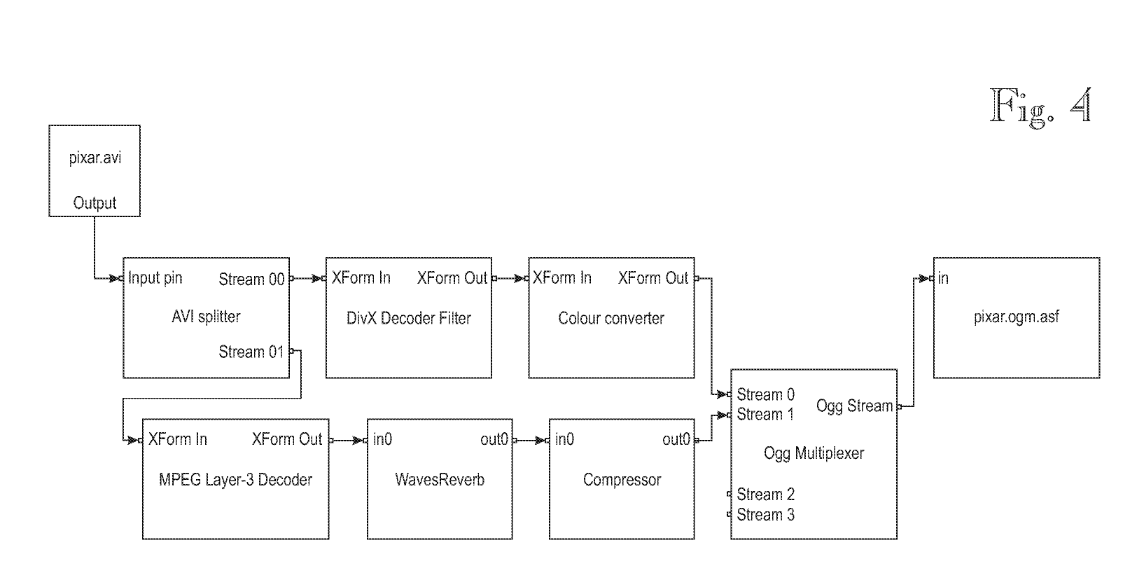

The parser or demultiplexer (“demux”) thread 308 parses a bit stream, ie, arranges it to separate but logically interconnected partial bit streams. For example, assuming that the bit stream to be parsed is a movie, the parser thread may separate the movie's multiple audio, video and subtitle streams to separate decoder threads, as will be shown in more detail in FIG. 4. The parser thread 308 may also perform corrective functions, such as re-clocking timed compressed audio/video samples. In the implementation shown in FIG. 3, each thread provides buffers 318₁ through 318₅ for its immediate predecessor thread. For example, the parser thread 308 provides buffers for the reader thread 306.

Each of the multiple decoder threads 310 decodes specific media type samples to raw media formats by using internal and/or external codecs. When DRM is enabled, only the internal codecs are permitted. The decoder threads 310 also provide buffers for the parser thread 308.

The encoder threads 312 will be described next. In some implementations, profiles may be used to define which encoder(s) will be used to create which output formats. Each encoder thread encodes samples of a specific raw media type by using one or more internal or external codecs. When DRM is enabled, only the internal codecs are permitted. The encoder thread(s) 312 also provides buffers for the decoder thread(s) 310.

Multiplexer (“Muxer”) threads 314 combine encoded audio and/or video samples to form a multiplexed bit stream. With multiplexer thread(s) also, profiles may be used to define which multiplexers create what kinds of output streams.

Writer thread(s) 316 output the outcome of the transcoding process. Depending on applicable profile(s), one or more writer thread(s) may be active. The writer thread(s) may output the outcome to a disk file, to a memory area or to a peripheral port, such as a network stream or USB device.

It was stated earlier that the transcoding component according to the invention preferably employs a static linking of the internal transcoding subcomponents.

As used herein, static linking means two feature simultaneously, namely a static library and a static chain of transcoding subcomponents used in any given transcoding process. In computer science, a static library, also referred to as a statically-linked library, refers to a technique wherein links to external functions and variables in a caller are resolved at compile-time. Static libraries are merged with other static libraries and object files during building/linking to form a single executable piece of software. The static chain of transcoding subcomponents used in any given transcoding process may be defined by a profile assigned to the transcoding process. The profile may indicate which transcoding subcomponents are active (actually employed) and which are in bypass mode.

The static linking provides certain benefits. For instance, the static linking of the internal transcoding subcomponents makes the transcoding component less vulnerable to hacking because there are no open sockets or other programming interfaces via which fraudulent modules may engage to the transcoding process. In addition, the static linking improves transcoding speed because inter-process communication does not have to support open programming interfaces. In some implementations, communication between threads is accomplished by means of pointer passing, in which a successor thread provides its predecessor thread with a pointer to a buffer area. This technique eliminates the need to copy memory between threads or processes.

The static linking may not seem like an attractive design choice for a couple of reasons. For instance, the static linking means that the transcoding component according to the invention is poorly or not at all extendible to new encoding formats. Rather, it must contain all the necessary codecs for any foreseeable transcoding usage. When new codecs are needed, the entire transcoding component must be changed. Thus the improvement to DRM security/integrity may sacrifice support for new data formats. However, some implementations of the invention enforce the prohibition of external transcoding components and/or intermediate files only when DRM is enabled, whereby the transcoding component may be extendible via external transcoding components when DRM is disabled. Another apparent drawback of the static linking is that information must be conveyed via transcoding subcomponents which may not be necessary for a particular transcoding process. For this reason, the transcoding subcomponents should preferably have a high-speed bypass mode in which they merely pass information without transforming it in any way.

In a typical but non-restrictive implementation, a transcoding component according to the invention comprises codecs for the following formats:
ASF, MPEG, 3GPP bit streams and raw bit streams;
AMR, MC (incl. AAC+ and eAAC+), MP3, PCM, SMAF and WMA audio formats;
H.263, MPEG2, MPEG4, WMV and VP6 video formats.

FIG. 4 shows an exemplary linking of processes for video conversion from an AVI file to an OGM file. Based on the foregoing description, FIG. 4 is believed to be self-explanatory to a skilled reader.

Memory management and memory usage will be described next. As is well known to programmers, allocating and de-allocating memory tends to result in memory fragmentation, which in turns results in lowered system performance. Allocating and de-allocating memory, and the resulting memory fragmentation, may be reduced by a technique in which the transcoding subcomponents re-use the same memory buffers. This technique also prevents components from accidentally writing over data that has not been processed, because the allocator maintains a list of available samples.

In this technique, the multimedia framework has a memory allocator that creates a finite pool of buffers during the initialization of conversion process. At any time, some buffers may be in use, while others are available. The allocator uses reference counting to keep track of which buffers are used. The allocator provides a method which returns a buffer with a reference count of 1. If the reference count goes to zero, the buffer is returned into the allocator's pool, from where it can be re-used. As long as the reference count remains above zero, the buffer is not available. If every buffer belonging to the allocator is in use, the next request for new buffer will be blocked until a buffer becomes available.

In a best-case scenario, a single media buffer can propagate via the entire chain of the transcoding subcomponents. This is possible if the output of the process is no larger than the input of the process and processing can be performed in place, without copying to a new buffer. Some steps can be taken to make this best-case scenario to happen more often. For instance, buffer size can be made larger than any single sample used during the process. Instead, or additionally, valid data may be located in the middle of original buffer such that there is sufficient empty space in the beginning and in the end of buffer to be used in intermediate steps. Also, when the destination stream is located in the memory and has a header of a fixed size, direct writing to the final location may be used instead of normal buffer usage.

It is readily apparent to a person skilled in the art that, as the technology advances, the inventive concept can be implemented in various ways. The invention and its embodiments are not limited to the examples described above but may vary within the scope of the claims.

1. A software product (300) for media content transcoding, wherein the software product:
is a software component configured to be executed under a software application;
contains a plurality of internal transcoding subcomponents (310, 312) for transcoding a plurality of audio and/or video formats;
contains DRM support code (306, 316) for digital rights management [“DRM”], wherein the DRM has at least an enabled state and wherein the DRM support code contains subcomponents for supporting a plurality of media container formats; and
wherein, at least when said DRM is in the enabled state, the software product is configured to perform said transcoding without intermediate files and by using only said internal transcoding subcomponents (310, 312) for transcoding.

2. A software product according to claim 1, wherein the software product is configured to use a static linking of the internal transcoding subcomponents at least when said DRM is in the enabled state.

3. A software product according to claim 1 or 2, wherein the software product is configured to distribute a plurality of tasks among a plurality of threads (306-316) executed simultaneously.

4. A software product according to claim 3, wherein the plurality of threads communicate with each other asynchronously.

5. A software product according to any one of the preceding claims, wherein the DRM has a disabled state in addition to the enabled state, and wherein at least one restriction is relaxed when the DRM is in the disabled state.

6. A software product according to any one of the preceding claims, wherein the software product:
has no user interface of its own;
is configured to be executed only under the software application, and wherein the software application provides a user interface for accessing the software product's functionality.

7. A software product according to any one of the preceding claims, wherein the software product is configured to be executed in a client computer system.

8. A computer system comprising a software product according to claim 1.

9. A method for transcoding media content, the method comprising transcoding media content by a software product according to claim 1.
